(19) United States
(12) Patent Application Publication
(10) Pub. No.: US 2013/0043156 A1
(43) Pub. Date: Feb. 21, 2013

(54) GIFT CARD HANGER SYSTEM

(71) Applicant: Brett R. Glass, Overland Park, KS (US)

(72) Inventor: Brett R. Glass, Overland Park, KS (US)

(73) Assignee: Gift Card Impressions, LLC, Overland Park, KS (US)

(21) Appl. No.: 13/371,471

(22) Filed: Feb. 12, 2012

Related U.S. Application Data
(63) Continuation-in-part of application No. 13/114,893, filed on May 24, 2011.
(60) Provisional application No. 61/441,835, filed on Feb. 11, 2011.

(51) Int. Cl. B65D 85/00; F16M 13/02

(52) U.S. Cl. 206/449; 248/317

(57) ABSTRACT

A system for hanging a gift card includes a gift card assembly suspended from a gift card holder assembly by a looped strip of flexible material. The gift card assembly includes a removeably attached gift card and the gift card holder assembly includes a gift card holder for receiving the gift card after detachment from the gift card assembly.

### CROSS REFERENCE TO RELATED APPLICATIONS

This application is a continuation in part of application Ser. No. 13/114,893, filed May 24, 2011 and claims the benefit of the prior filed, co-pending provisional application Ser. No. 61/441,835, filed Feb. 11, 2011.

### BACKGROUND OF THE INVENTION

This invention relates generally to gift cards and more particularly to a device for suspending or hanging a gift card from a gift card holder or greeting card.

Transaction cards, stored value cards, or gift cards as they are commonly called based upon their intended use, have become popular gifts. Gift cards typically comprise a stored value card whereby a certain cash equivalent value is encoded upon a magnet strip applied to the surface of the card. This stored value may be determined by the vendor prior to packaging and display for sale or, more commonly, is selected at the point of sale by the purchaser and loaded by the cashier using a magnet card reader/writer.

### BRIEF DESCRIPTION OF THE INVENTION

The purpose of this invention is to provide a means for hanging or suspending a conventional gift card mounted on a backer card or panel from a greeting card or gift card holder. The gift card holder typically includes indicia for indicating both the name of the sender and recipient of the gift card, decorations of various styles or themes, and one or more slots for inserting a gift card into the holder or other means such as adhesive for holding the gift card to or within the hold structure. The holder may be mounted on a first backer panel that includes a peg hole for hanging the first backer panel and attached holder upon a display rack peg. The holder may include electronics for recording and playing sound such as music and/or a message from the gift giver. The electronics may include a sound speaker, a power source such as one or more commonly available watch batteries, a control circuit, a memory chip for storing sound recordings, and record and playback buttons.

The gift card is typically mounted on a second backer panel that is also provided with a peg hole for either hanging the second backer panel upon a display rack peg or for use within the system disclosed herein. The gift card may be disposed upon the second backer panel so that the magnetic strip of the gift card projects below the lower margin of the second backer panel, or the second backer panel may be provided with a fold line, either structure thereby enabling the gift card magnetic strip to be scanned at the point of sale. Alternatively, in the case of a gift card provided with a bar code or other optically scannable indicia on the back of the gift card, the second backer panel may include a window in alignment with the scannable indicia so that the indicia may be scanned without removing the gift card from the second backer panel.

A strip or tab of acetate, plastic, paper or the like projecting from the lower margin of the first backer panel is looped through the peg hole of the second backer panel and then affixed via adhesive or equivalent means to a surface of the first backer panel to form a loop by which the second backer panel and attached gift card may be hung or suspended from the first backer panel and/or gift card holder.

After purchase of the assembly comprising the gift card holder and gift card, the gift card may be removed from the second backer panel and installed within or upon the gift card holder. In certain embodiments, the gift card holder may then be detached from the first backer panel prior to giving the gift card holder bearing the gift card to a gift recipient.

A gift card hanger system according to the present invention may include a gift card assembly attached to a gift card holder assembly by suspending the gift card assembly from the holder assembly by a looped tab secured at either end to the gift card holder assembly. The gift card assembly may include a panel bearing an attached gift card. The gift card holder assembly may include a panel bearing a gift card holder.

A gift card holder system according to the present invention may include a gift card holder assembly including a first backer panel, a detachable gift card holder attached to a face of the first backer panel, an elongated tab extending from a lower portion of the first backer panel, the tab including a free end, and a second backer panel including means for temporarily holding a gift card, the second backer panel including an aperture for accepting the free end therethrough, the first backer panel including means for attaching the free end to the first backer panel. The holder may include two hingedly connected panels and a means for holding a gift card. The holder may include three hingedly connected panels and a means for holding a gift card. The holder may include a container including a flap closure.

Other advantages of the invention will become apparent from the following description taken in connection with the accompanying drawings, wherein is set forth by way of illustration and example an embodiment of the present invention.

### BRIEF DESCRIPTION OF THE DRAWINGS

FIG. 1 is a front view of a gift card mounted upon a gift card backer panel prior to installation upon a gift card holder backer panel.

FIG. 2 is a side view of a gift card holder backer panel showing the tab projecting from the lower margin of the holder backer panel and partially bent upward and rearward.

FIG. 3 is a rear view of a holder backer panel.

FIG. 4 is a front view of a gift card backer panel suspended from a holder backer panel via a looped tab.

FIG. 5 is a front view of second backer panel.

FIG. 6 is a rear view of the second backer panel of FIG. 5 showing a fold line.

FIG. 7 is a side view of the second backer panel of FIG. 6 showing the lower portion of the second backer panel lifted upward and rearward and away from the lower portion of the gift card.

FIG. 8 is a front view of a second backer panel showing the gift card mounted to project below the bottom edge of the panel.

FIG. 9 is a rear view of the second backer panel of FIG. 8 showing the gift card magnetic strip.

FIG. 10 is a rear view of a second backer panel provided with a window for exposing a gift card bar code.

FIG. 11 is a front view of a gift card assembly suspended from a gift card holder assembly and showing the upper flap of a gift card holder lifted to show interior details.

FIG. 12 is a front view of an alternative embodiment of a gift card holder assembly having a tab formed integrally from the gift card holder backer panel.

FIG. 13 is a rear view of the gift card holder assembly of FIG. 12.

FIG. 14 is a front view of an alternative embodiment of a gift card hanger system showing a gift card assembly suspended from a gift card holder assembly by a looped tab integral to the gift card holder backer panel.

FIG. 15 is a rear view of the hanger system of FIG. 14.

FIG. 16 is an illustration of an alternative embodiment of a gift card hanger system wherein the gift card holder comprises a removable bag.

FIG. 17 is an illustration of an alternative embodiment of a gift card hanger system wherein the gift card holder comprises popup elements.

FIG. 18 is an illustration of an alternative embodiment of a gift card hanger system wherein the gift card holder comprises elements for retaining and presenting a gift card.

FIG. 19 is front view of an alternative embodiment of a gift card hanger system wherein the gift card holder comprises three hingedly connected panels including a pocket for retaining an inserted gift card, indicia for prompting user indication of a gift giver, gift recipient and message, audio components for providing sound upon opening the holder and means for retaining the left and right panels of the holder in a closed position.

FIG. 20 is a front view of the holder of FIG. 19 showing the right panel closed upon the center panel.

FIG. 21 is a front view of the holder of FIG. 20 showing the left panel closed upon the right panel to render the holder in a fully closed disposition.

FIG. 22 is a front view of an alternative embodiment of a gift card hanger system showing a gift card assembly suspended from a gift card holder assembly by a looped tab integral to the gift card holder backer panel and wherein the gift card holder comprises an envelope assembly.

FIG. 23 is a rear view of the hanger system of FIG. 22.

FIG. 24 is a front view of the hanger system of FIG. 22 showing the front panel opened away from the rear panel.

FIG. 25 is a front view of the gift card holder backer panels showing the hinge line and adjacent glue lines that operate to join the front and rear panels.

FIG. 26 is a front perspective view of an embodiment of a gift card holder that may be mounted on the front backer panel.

FIG. 27 is a front perspective view of an embodiment of a gift card holder that may be mounted on the front backer panel.

FIG. 28 is a side perspective view of an embodiment of a gift card holder that may be mounted on the front backer panel.

FIG. 29 is a rear view of a presentation envelope used to house a gift card holder after removal from the front backer panel.

FIG. 30 a front view of the envelope of FIG. 29.

FIG. 31 is a front view of a (typically plastic and transparent) folder used to house the envelope and gift card holder when mounted to the front back panel.

FIG. 32 is a sectional side view showing the envelope and gift card holder with pop-up elements disposed within the folder.

FIG. 33 is a front view of an alternative embodiment of a gift card hanger system showing a gift card assembly suspended from a gift card holder assembly and wherein the gift card holder comprises box with cover flap.

FIG. 34 is a front view of the hanger system of FIG. 33 showing the cover flap in an open disposition.

FIG. 35 is a rear view of the hanger system of FIG. 33 showing the gift card assembly removed.

FIG. 36 is a rear view of the hanger system of FIG. 33 showing the gift card assembly suspended from the gift card holder assembly by a looped tab integral to a reduced size, T-shaped gift card holder backer panel.

FIG. 37 is a front view of an alternative embodiment of a gift card hanger system showing a gift card assembly suspended from a gift card holder assembly and wherein the gift card holder comprises a pleated bag held to the gift card holder backer panel by tabs.

FIG. 38 is a side view of the system of FIG. 37.

FIG. 39 is a rear view of the backer panel.

FIG. 40 is a rear view of the backer panel.

FIG. 41 is a front view of an alternative embodiment of a gift card hanger system showing a gift card assembly suspended from a gift card holder assembly and wherein the gift card holder backer panel comprises a reduced size, T-shaped gift card holder backer panel.

FIG. 42 is a rear view of the system of FIG. 41 showing tear-away tabs projecting from the backer panel to adhere to the back surface of a mounted gift card holder.

FIG. 43 is a front view of a reduced size, T-shaped gift card holder backer panel.

FIG. 44 is a rear view of a reduced size, T-shaped gift card holder backer panel.

FIG. 45 is a front view of an alternative embodiment of a gift card hanger system showing a gift card assembly suspended from a gift card holder assembly and wherein the gift card holder comprises a box for housing a sliding gift card carrier panel.

FIG. 46 is a front view of the system of FIG. 45 showing a box flap in an open position and a carrier panel partially removed from the box.

FIG. 47 is a front view of the system of FIG. 45 showing the box tilted upward and away from the backer panel.

FIG. 48 is view of the front and rear backer panels of the system of FIG. 22 showing the rear surface of the rear panel and the front surface, including glue lines, of the front panel.

FIG. 49 is a view of the reverse surfaces of the backer panels of FIG. 48.

### DETAILED DESCRIPTION

As required, one or more detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

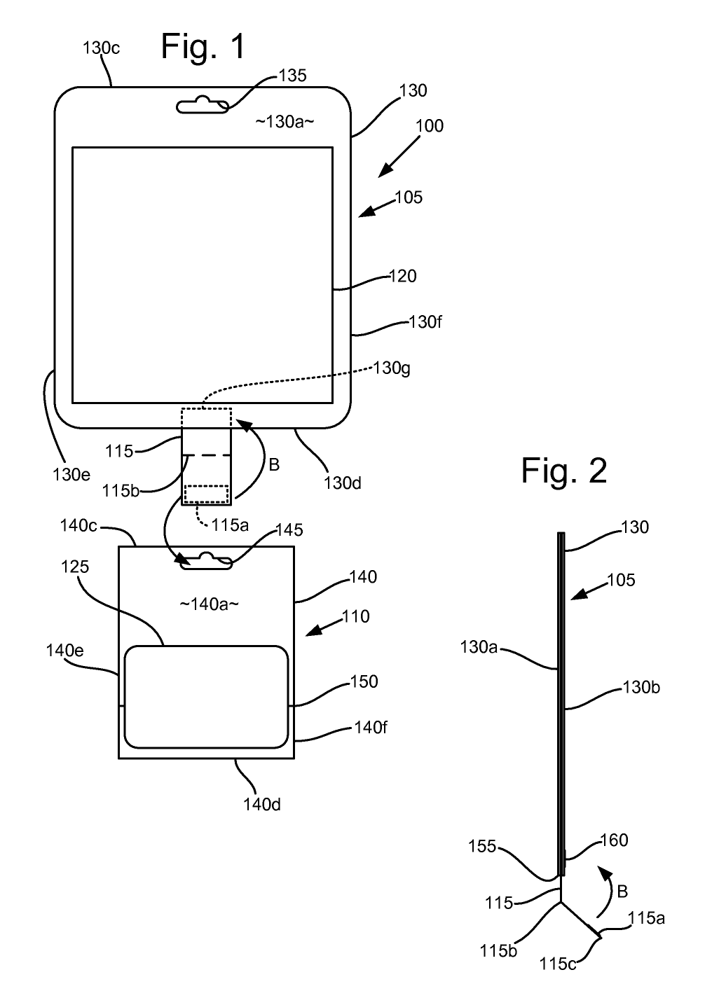

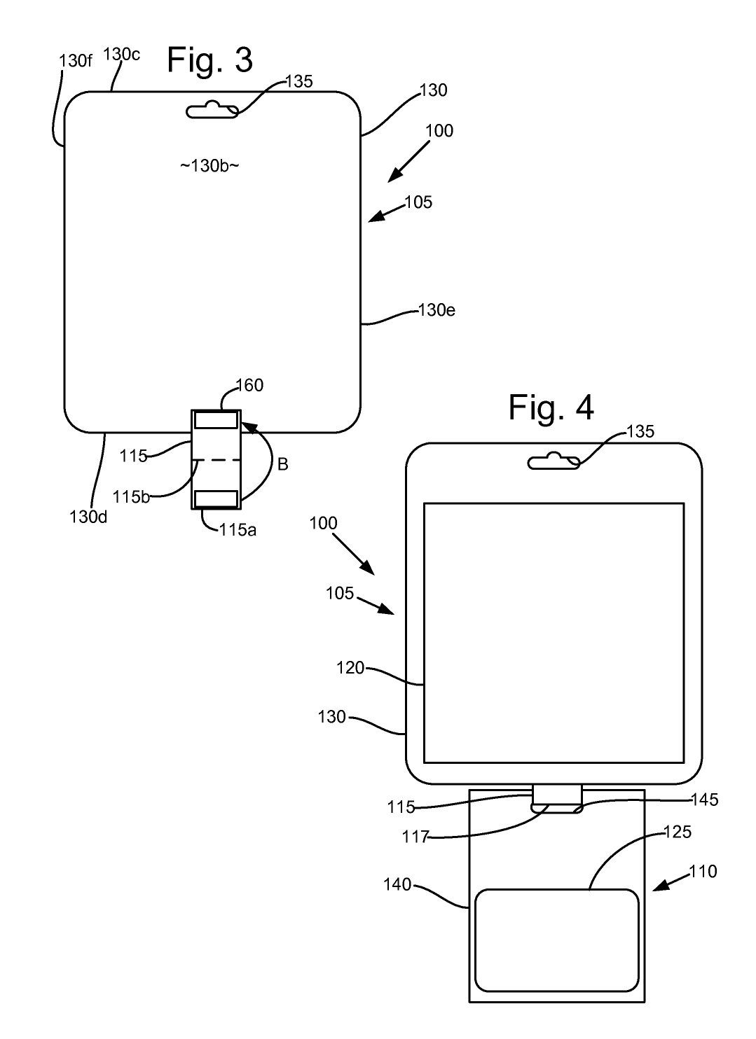

Referring now to FIGS. 1 through 4, there is shown an embodiment of a system for hanging a gift card as indicated generally by the reference numeral 100. The system 100 includes a gift card holder assembly 105 and a gift card assembly 110. The holder assembly 105 and gift card assembly 110 are attached to one another in a novel manner, namely by suspending the gift card assembly 110 from the holder assembly 105 via a strip or tab 115.

The holder assembly 105 includes a gift card holder 120 for holding, retaining or storing a gift card 125 after removal of the gift card 125 from the gift card assembly 110. The holder 120 is typically formed of one or more relatively planar panels of cardstock or the like and typically includes indicia thereon for indicating both the name of the sender and recipient of a gift card 125, indicia for indicating a message thereon from the sender to the recipient, decorations of various styles or themes, and one or more slots for inserting a gift card 125 into the holder 120, or other means for holding the gift card 125 to, or within, the holder structure. When presented for sale, the holder 120 is typically mounted on a first backer panel 130 typically formed of card stock or the like. The first backer panel 130 includes a front surface 130a, rear surface 130b, top edge 130c, bottom edge 130d, left edge 130e and right edge 130f. A peg hole 135 is typically provided proximate the top edge 130c for hanging the first backer panel 130 and attached holder 120 upon a display rack peg (not shown). The holder 120 may include electronics for recording and playing sound such as music and/or a message from the gift giver. The electronics may include a sound speaker, a power source such as one or more commonly available watch batteries, a control circuit, a memory chip for storing sound recordings, and record and playback buttons.

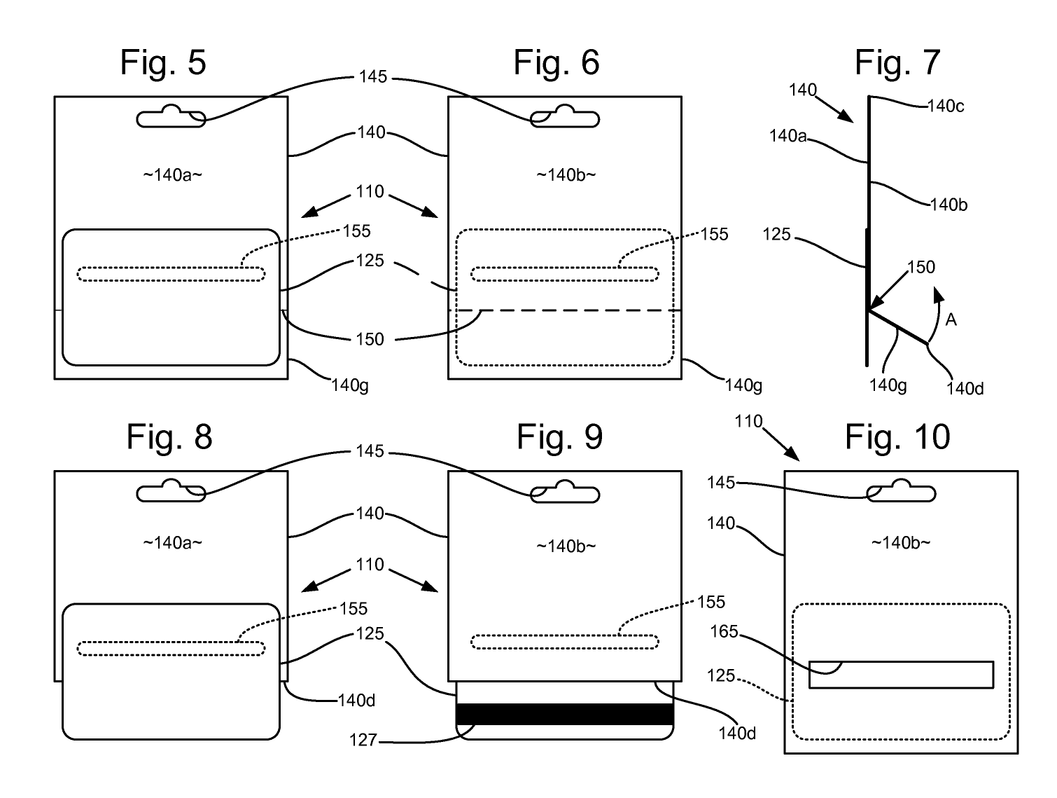

A gift card 125, typically provided with a magnetic strip, bar code and/or ID number associated with one or more monetary values or monetary accounts, is mounted on a second backer panel 140 using temporary or removable adhesive 155 or other operable means. In FIGS. 5 and 6, a strip of removable adhesive 155 (shown in phantom lines) is interposed between the gift card 125 and the front surface 140a of the second backer panel 140 to adhere the gift card 125 to the second backer panel 140.

The second backer panel 140 includes a front surface 140a, rear surface 140b, top edge 140c, bottom edge 140d, left edge 140e and right edge 140f. The second backer panel 140 is also typically provided with a peg hole 145 proximate the top edge 140c that may be used either for hanging the second backer panel 140 upon a display rack peg or for use within the system 100 disclosed herein.

As shown in FIGS. 5, 6 and 7, the second backer panel 140 may be provided with a fold line 150 that extends transversely across the second back panel 140 between the left edge 140e and right edge 140f. The fold line 150 and gift card 125 are positioned relative to each other so that the portion of the second backer panel 140 bearing the adhesive 155 (or other means of retaining or attaching the gift card 125 to the second backer panel 140) lies above the fold line 150. Typically, the fold line 150 will transverse the lower portion of the second backer panel 140. At the point of purchase of an apparatus according to the system 100, the gift card 125 is typically scanned by the cashier to activate the gift card 125 or load it with a monetary or other value. To facilitate scanning, the bottom edge 140d of the second backer panel 140 is lifted upward, in the direction of arrow A, as shown in the side view of the second backer panel 140 in FIG. 7. The lower portion 140g of the second backer panel 140 that pivots about the fold line 150 may be referred to as a flap 140g. After the flap 140g is lifted, the magnetic strip 127 of the gift card 125 may be inserted into the slot of a magnet card reader or scanner (not shown) without interference from the lower portion of the second backer panel 140.

Alternatively, as shown in FIGS. 8 and 9, the gift card 125 may be disposed upon the second backer panel 140 so that the magnetic strip 127 of the gift card 125 projects below the bottom edge 140d of the second backer panel 140. As shown in FIGS. 8 and 9, a shortened version of the second backer panel 140 may be used to expose the lower portion of the gift card 125 while retaining the same space above the gift card 125 on the front surface 140a of the second backer panel 140. Alternatively, the gift card 125 may simply be positioned further down upon the second backer panel 140. In such case, the fold line 150 may be omitted. Either structure enables the magnetic strip 127 to be readily scanned at the point of sale by passing exposed lower portion of the gift card 125, including the magnetic strip 127, through a card reader (not shown) without the need for removing the card 125 from the second backer panel 140.

Alternatively, in the case of a gift card 125 provided with a bar code or other optically scannable indicia on the back of the gift card 125, the second backer panel 140 may include an opening, aperture or window 165 in alignment with the bar code so that it may be scanned (typically at the point of sale) without removing the gift card 125 from the second backer panel 140. FIG. 10 provides a rear view of a second backer panel 140 showing the rear surface 140b and a window 165 in the lower portion of the second backer panel 140 disposed to align with a bar code on a rear surface of a gift card 125. The gift card 125, which is mounted on the front surface 140a, is indicated in phantom lines.

The gift card holder assembly 105 is provided with a strip or tab 115 projecting from the bottom edge 130d of the first backer panel 130. The tab 115 may be formed of acetate, plastic, paper or the like. Any operable material may be selected of appropriate flexibility and strength. As shown in FIG. 2, the upper portion of the tab 115 may be sandwiched and secured between front and back cooperating panels that form the first backer panel 130. Alternatively, and particularly when the first backer panel 130 is formed from a single sheet of material, the tab 115 may simply be attached to the front surface 130a or more preferably the rear surface 130b.

In order to assemble an apparatus according to the system 100, the tab 115 is looped through the peg hole 145 of the second backer panel 140 and then affixed via adhesive 160 (such as a section of double stick tape) or equivalent means to a surface, preferably the rear surface 130b, of the first backer panel 130 to form a loop 117 by which the gift card 125 may be suspended from the gift card holder 120. As shown in FIGS. 1 and 2, the lower portion of that tab 115 is lifted upward in the direction of arrow B to generally pivot around line 115b to thereafter contact a portion of the rear surface 130b of the first backer panel 130, as indicated by phantom lines 130g, to form the loop 117. It should be appreciated that the lower portion 115c of the tab 115 is first passed through the peg hole 145 prior to attachment to the rear surface 130b so that it forms a loop 117 holding the second backer card 140 to the first backer card 130 and, therefore, the gift card assembly 110 to the gift card holder assembly 105, as shown in FIG. 4.

In certain embodiments of the system 100, the lower portion of the tab 115 (typically the rearward surface) is provided with a strip of adhesive 115a that contacts and adheres to the rear surface 130b when the lower portion of the tab 115 is lifted to meet the first backer panel 140. In the other embodiments, the tab 115 is adhered to a section of double stick tape 160 located on the rear surface 130b after the tab 115 is passed through the peg hole 145.

After purchase of the system 100 comprising the gift card holder 120 and gift card 125, the gift card 125 may be removed from the second backer 140 and installed within or upon the gift card holder 120. In certain embodiments, the gift card holder 120 may then be detached from the first backer 130 card prior to giving the gift card holder 120 bearing the gift card 125 to a gift recipient. In further embodiments, an envelope is included with the system 100 and the gift card holder 120 is inserted into the envelope after it is detached from the second backer 140.

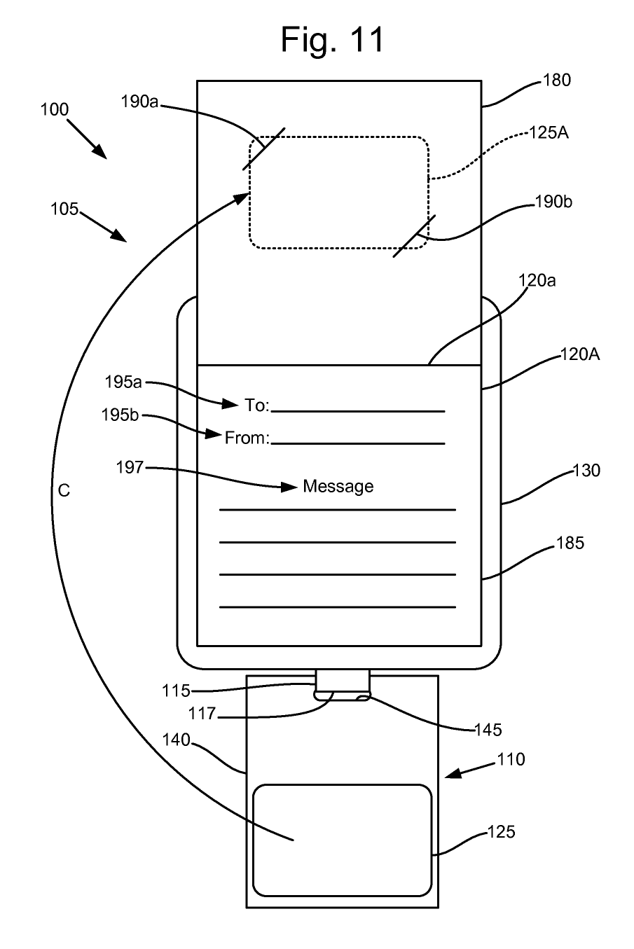

FIG. 11 illustrates an example of a gift card holder 120A comprising two flaps of cardstock or the like defined from one another by a hinge or fold line 120a. Typically, as when presented for sale, the upper flap 180 lies flat against the lower flap 185, however, in this illustration the upper flap 180 is shown lifted upward to expose interior details, namely, slits 190a and 190b in the upper flap 180, to/from indicia 195a and 195b and message indicia 197. After purchase of an apparatus according to the system 100, the gift giver (typically the buyer) may indicate the name of the gift recipient as prompted by the “To:” indicia 195a, the name of the gift giver as prompted by the “From:” indicia 195b, provide a written message is prompted by the “Message” indicia 197, and remove the gift card 125 from the second backer panel 140 and install it in the holder 120A as generally indicated by arrow C. The gift card 125 may be attached to or installed in the holder 120A by slipping diagonally opposing corners of the gift card into slits 190a and 190b as indicated in phantom lines 125A in FIG. 11.

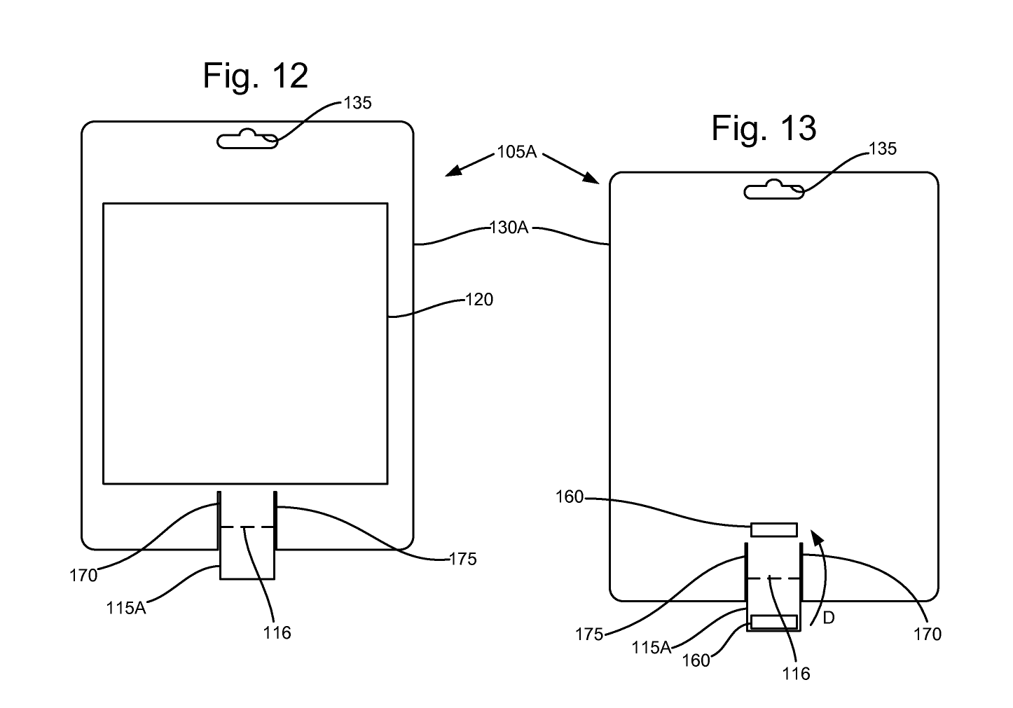

As illustrated in FIGS. 12 through 15, an alternative embodiment of the system 100A includes a first backer panel 130A with an integral strip 115A formed from the same piece of material (typically card stock, paper or the like) as the first backer panel 130A. FIG. 12 is a front view of an alternative embodiment of a gift card holder assembly 105A having a tab or strip 115A formed integrally from the gift card holder backer panel, i.e. first backer panel 130A. The strip 115A may be scored 116 to facilitate bending it in the general direction indicated by arrow D after looping it through the second backer panel 140 peg hole 145. Notches 170 and 175 in the first backer panel 130A, separate and define a portion (typically a major upper portion) of the strip 115A from the adjacent portions of the backer panel 130A.

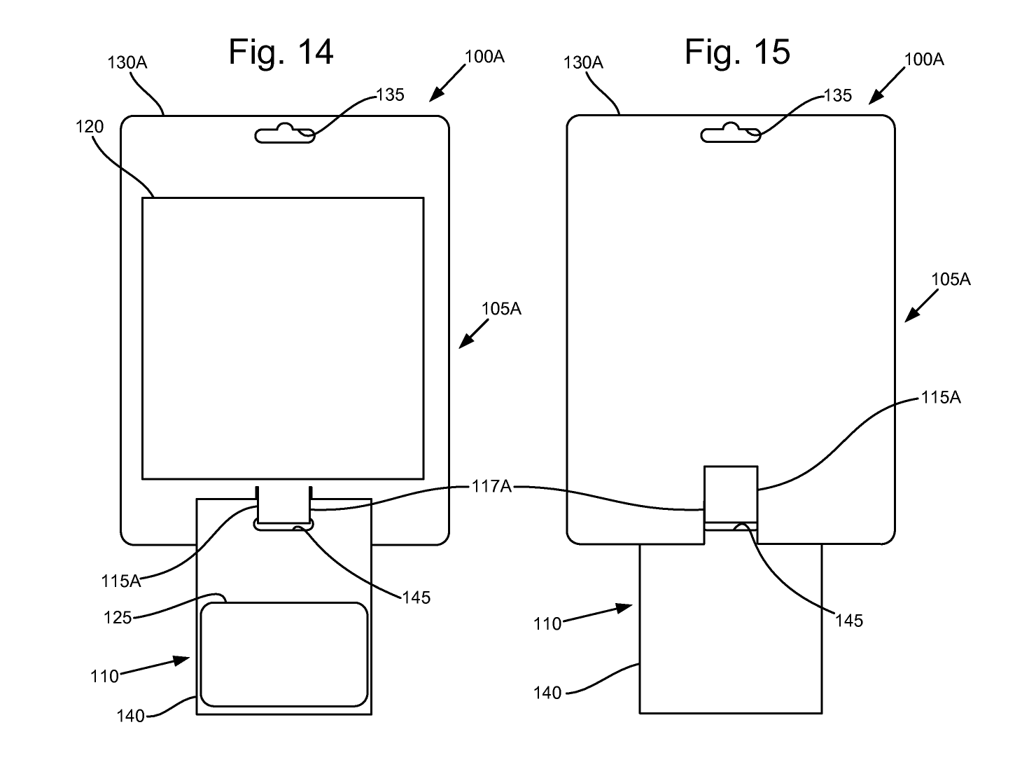

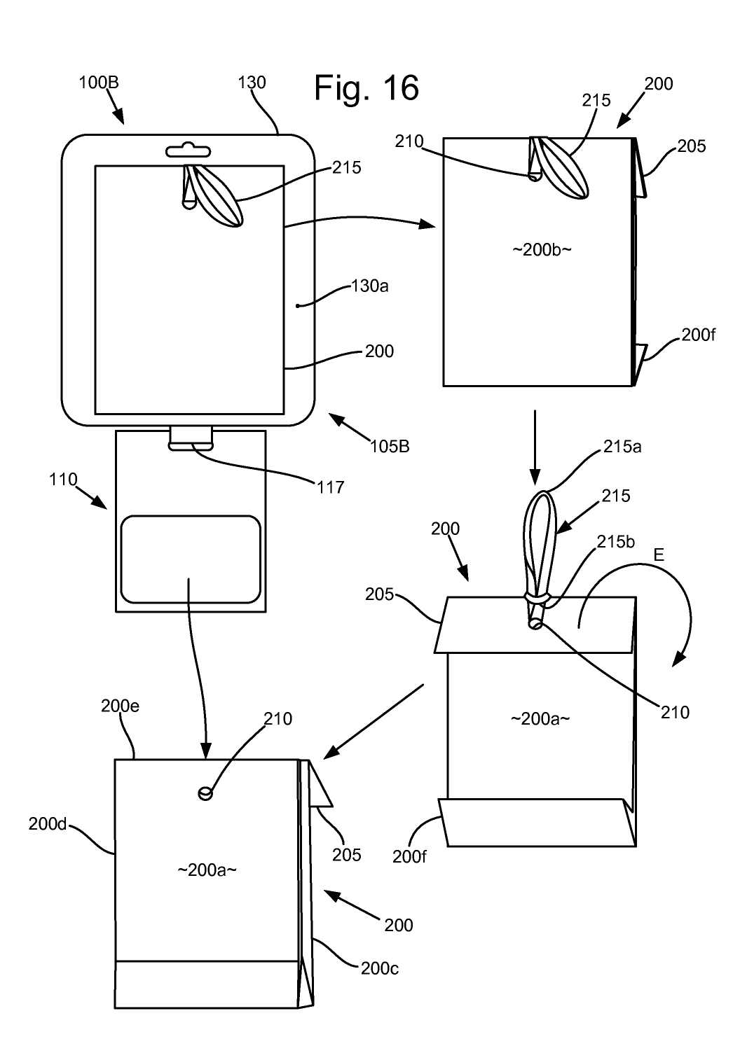

The notches 170 and 175 allow the second backer panel 140 to be drawn further upward and closer to the first backer panel 130A after the free end of the strip 115A is passed through the peg hole 145 and secured to the rear surface of the first backer panel 130A using adhesive 160 such as double stick tape or the like. As illustrated in FIG. 14, the upper portion of the second backer panel 140 slides into the notches 170 and 175 as the second backer panel 140 drawn upward by fastening the free end of the looped strip 115A to the back of the first backer panel 130A. Note that as indicated in FIG. 13, which shows a rear view of the first backer panel 130A, the adhesive may be placed near the free end of the strip 115A or on the rear surface of the first backer panel 130A at the point where the free end of the strip 115A will meet when secured to form a loop 117A. FIG. 14 is a front view of the gift card assembly 110 suspended from the gift card holder assembly 105A by the looped tab 115A integral to the gift card backer panel 130A. FIG. 15 is a rear view of the gift card assembly 110 suspended from the gift card holder assembly 105A via loop 117A.

FIG. 16 is an illustration of an alternative embodiment of a gift card hanger system 100B wherein the gift card holder 200 comprises a removable bag 200. The gift card assembly 110 is suspended from the gift card holder assembly 105B by loop 117, as described previously. The gift card holder comprises a sack or bag 200 that is folded and removably attached to the front surface 130a of the first backer panel 130. The bag 200 includes relatively planar front 200a and back 200b panels, pleated side panels 200c and 200d that extend between, and join, the front and back panels, an open end 200e, and an opposing closed end that is closed by bottom panel 200f. A closure flap 205 projects from the upper edge of the back panel 200b and can be folded downward and against the front panel 200a to cover the open end 200e. Loop holes 210 are formed in, and pass through, the front 200a and back 200b panels and flap 205 so that all loop holes 210 are in alignment with one another. A bag loop 215 comprising a closed loop of string, plastic, or fabric, is passed through the loop holes 210 in the flap, front panel and back panel and then the first end 215a of the loop 215 is passed through the second end 215b of the loop 215 in a conventional manner so that the loop 215 may be tightened against the bag 200 by pulling the first end 215a. As shown in the sequence illustrated in FIG. 16, after purchase of the gift card hanger system 100B, the bag 200 is removed from the first backer panel 130, the bottom panel 200f is folded downward, the loop 215 is removed from the loop holes 210, and the flap 205 is opened as generally indicated by arrow E to allow the bag 200 to receive the gift card 125 after it is removed from the second backer panel 140. After the gift card is inserted into the bag 200 through the open end of the bag 200, the flap 205 is closed and the loop 215 is retied through the loop holes 210 to secure the bag 200 in a closed disposition. The bag 200 may then be given as a gift with the gift card 125 inside.

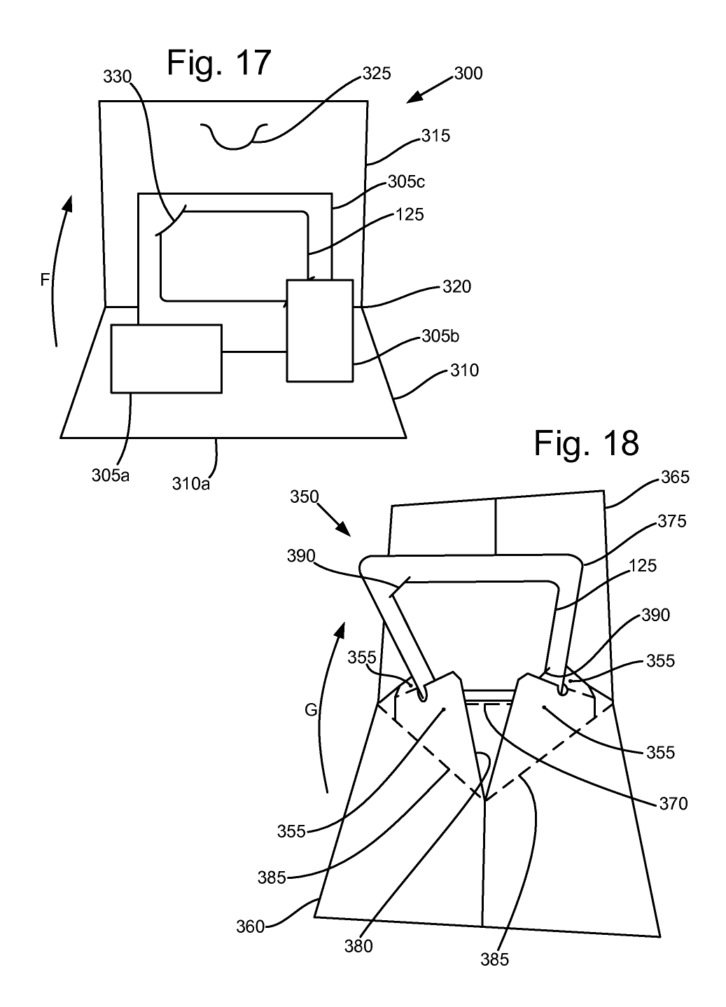

FIG. 17 is an illustration of an alternative embodiment of a gift card hanger system wherein the gift card holder 300 comprises popup elements 305. As shown in FIG. 17, a popup holder 300 may include a base or back panel 310 that may be removably attached, via removable adhesive or other operable means, to the front surface 130a of a first backer panel 130. A cover panel 315 is hingedly connected to the back panel 310 along line 320, which may be a fold line if the two panels 310 and 315 are formed from one sheet of cardstock or the like. A slit 325 is provided in the cover panel 315 for receiving the leading or forward edge 310a of the back panel 310 to secure the cover panel 315 (and the holder 300 itself) in a closed disposition. The holder 300 may include various popup elements 305a, 305b and 305c (collectively 305) attached to the supporting surfaces of the base panel 310 and/or cover panel 315 so that the popup elements 305 project outward from the plane of the supporting surfaces when the cover panel 315 is lifted away from the back panel 310 as generally indicated by arrow F and the holder 300 is opened. The popup elements 305 may comprise cardstock or other suitable material such as thin plastic or sufficiently rigid paper or cardboard. One or more popup elements 305, such as illustrated element 305c, may include slits 330 (typically diagonally opposed slits) for holding a gift card 125 after removal from the second backer panel 140.

FIG. 18 is an illustration of a further alternative embodiment of a gift card hanger system wherein the gift card holder 350 comprises finger elements 355 for retaining and presenting a gift card 125 in an upright or outward disposition. The holder 350 includes a first major panel 360 that may be removably attached, via removable adhesive or other operable means, to the front surface 130a of a first backer panel 130. A second major panel 365 is hingedly connected to the first major panel 360 along line 370, which may be a fold line if the two panels 360 and 365 are formed from one sheet of cardstock or the like. Two finger elements 355 project upward from each panel 360 and 365 to hold an insert element 375 in an upright or outward disposition from the panels 360, 365. The bottom edge of the insert 375 is attached to either the first 360 or second 365 major panel (it is shown attached to panel 365) in close proximity to line 370 and passes through transverse slits separating the first major panel 360 fingers 355 from the second major panel 365 fingers 355. An additional two longitudinal slits 380 divide and separate fingers 355 on a given panel 360 or 365. When the holder 350 is opened by lifting (generally in the direction of arrow G) the second major panel 365 from the underlying first major panel 360, the fingers 355 pivot about finger fold lines 385 and fold toward the panels 360 and 365. In doing so, the fingers 355 grip the insert 375 and hold it in an upright position relative to the major panels 360 and 365. As shown, a gift card 125 may be removed from the second backer panel 140 and attached to the insert 375 by slipping diagonally opposed corners of the gift card 125 into diagonally opposed slits 390 in the insert 375.

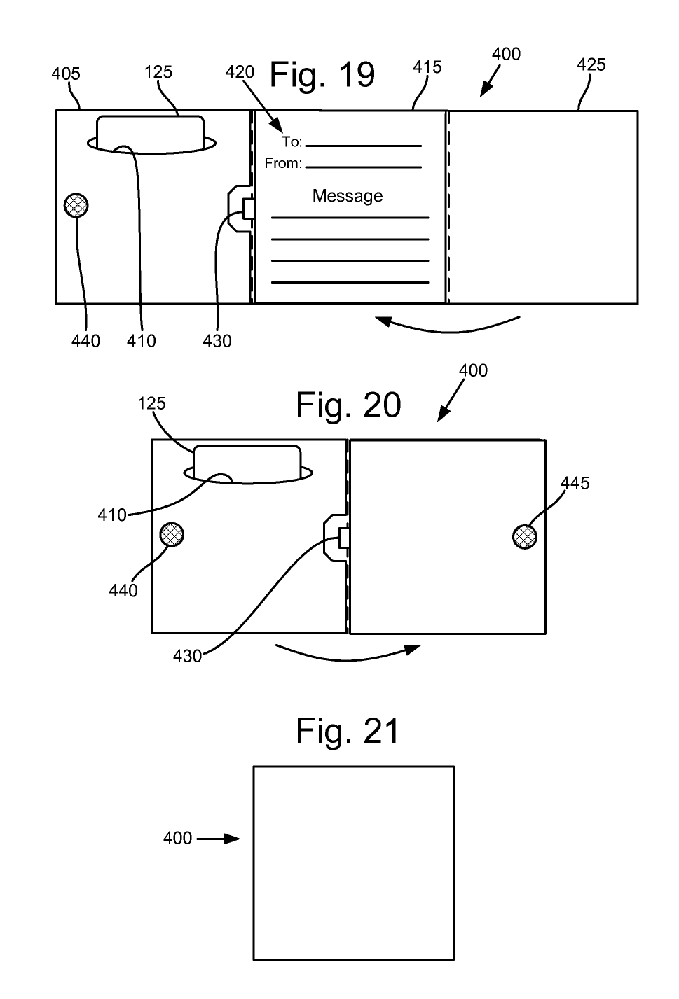

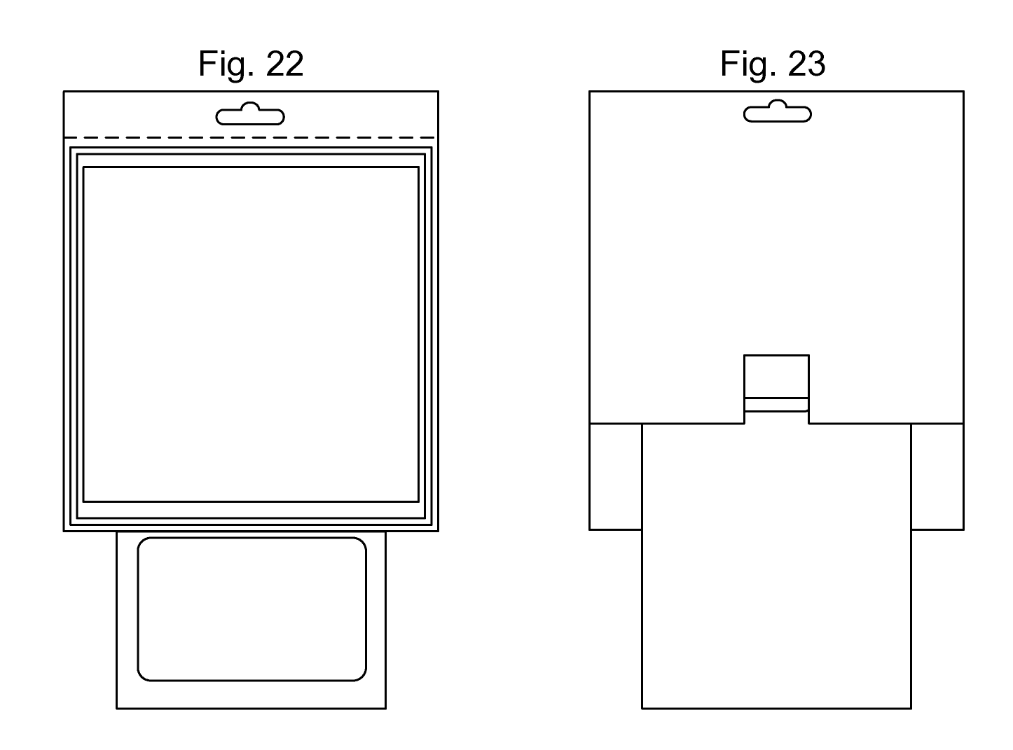

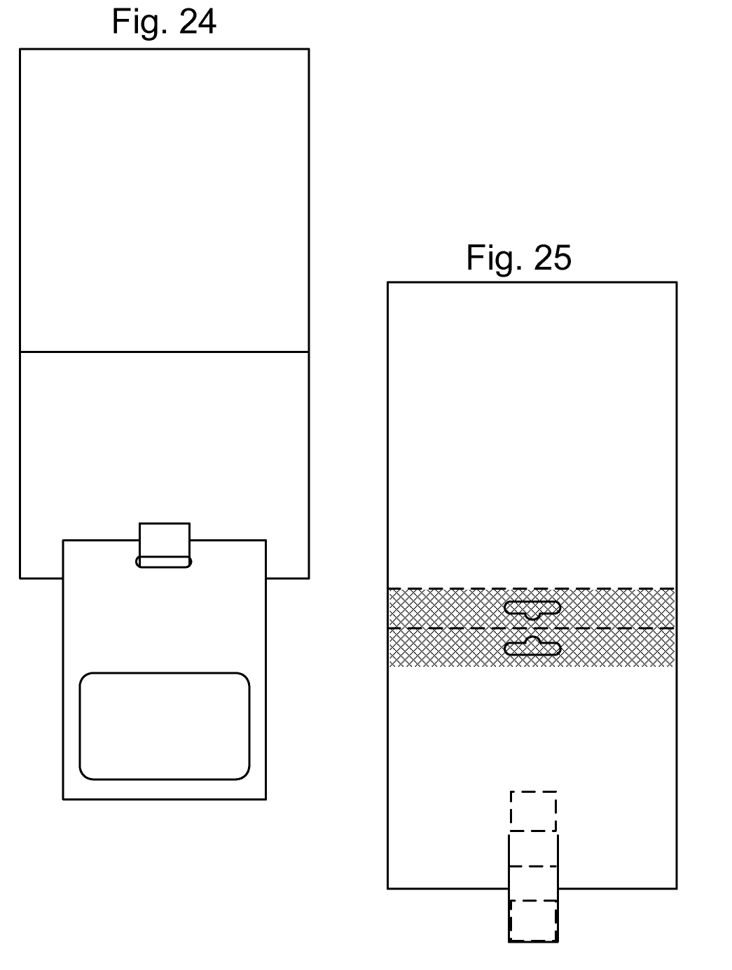

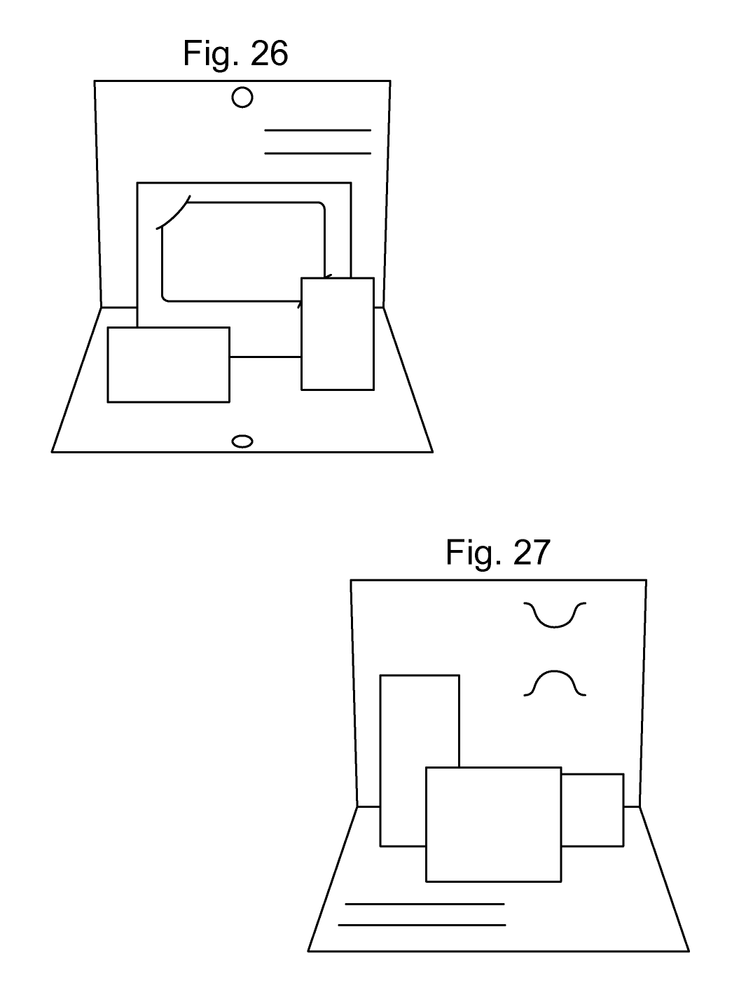

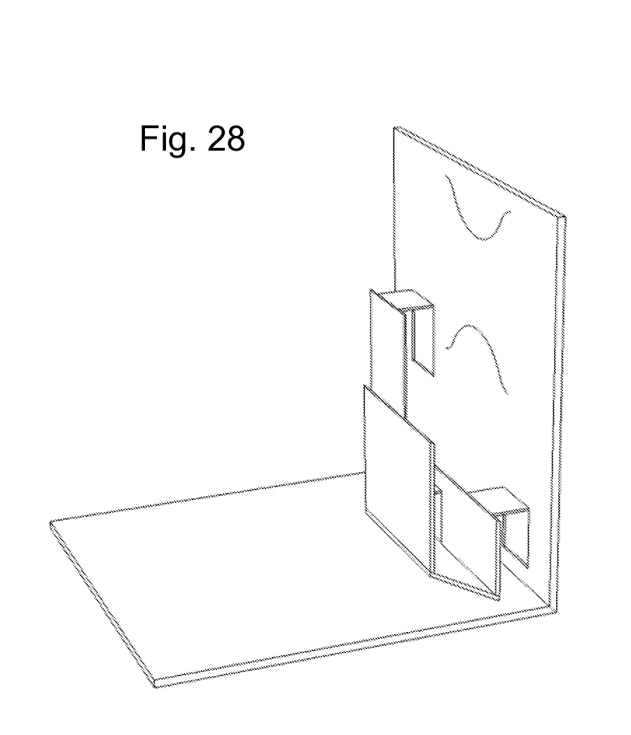

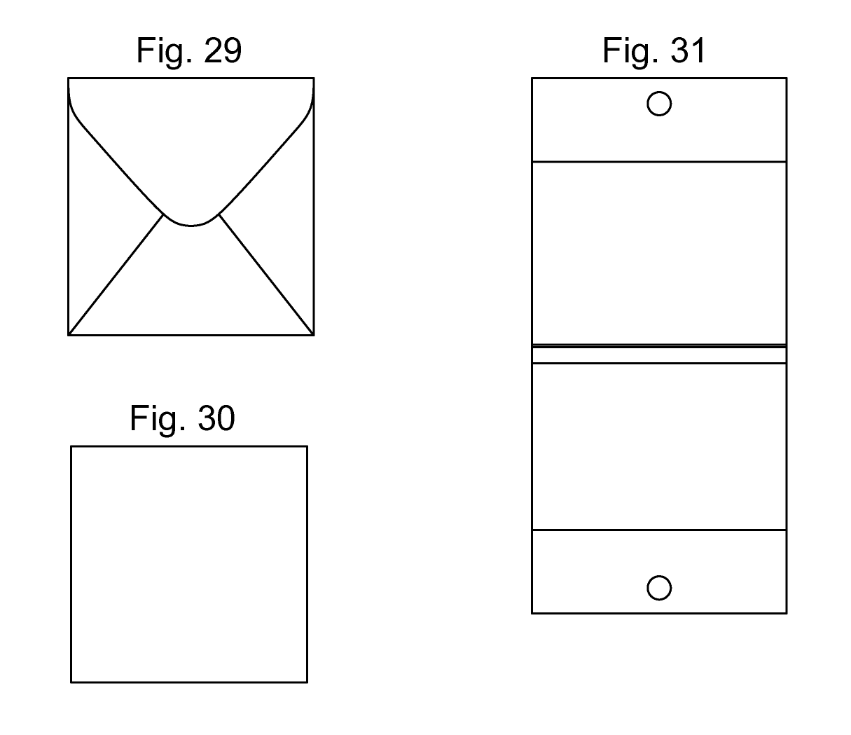

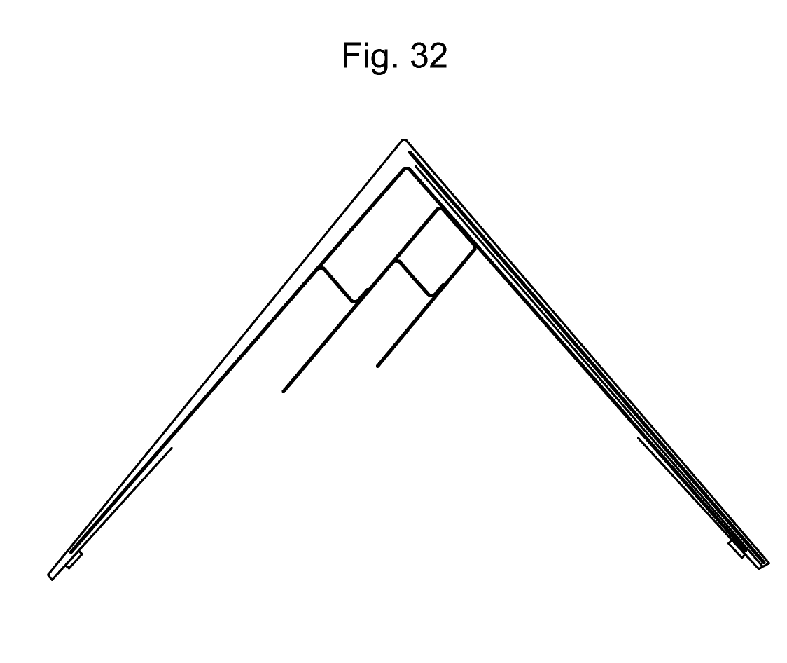

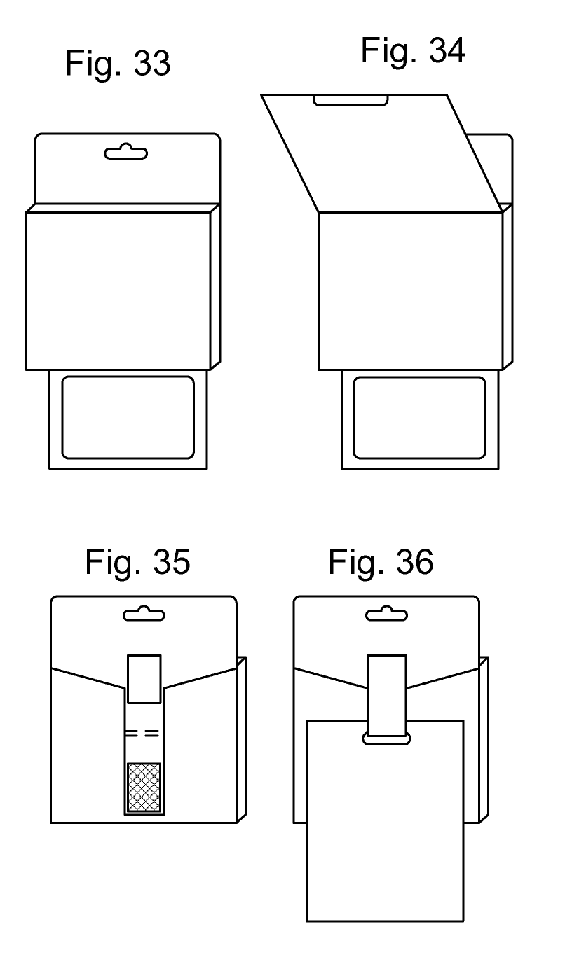

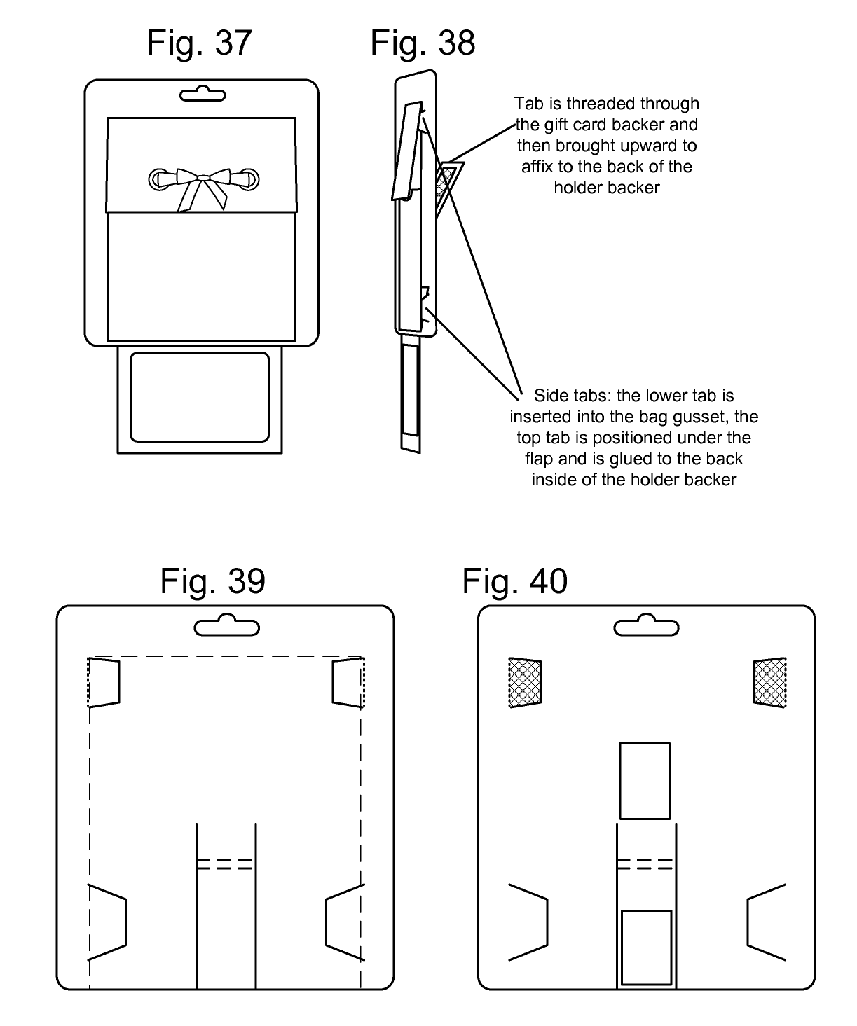

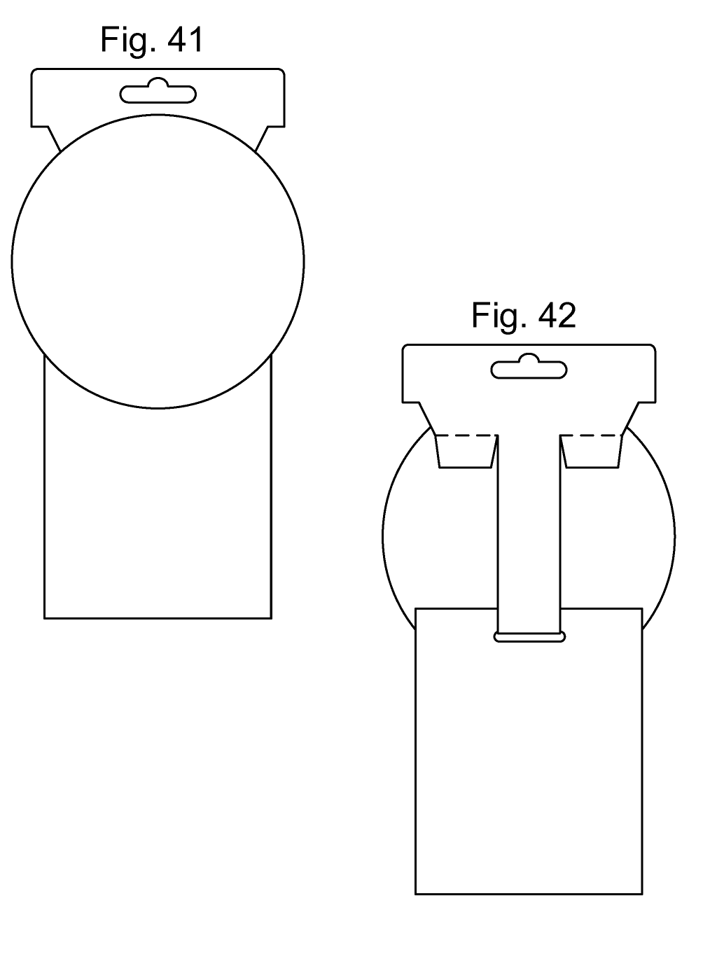

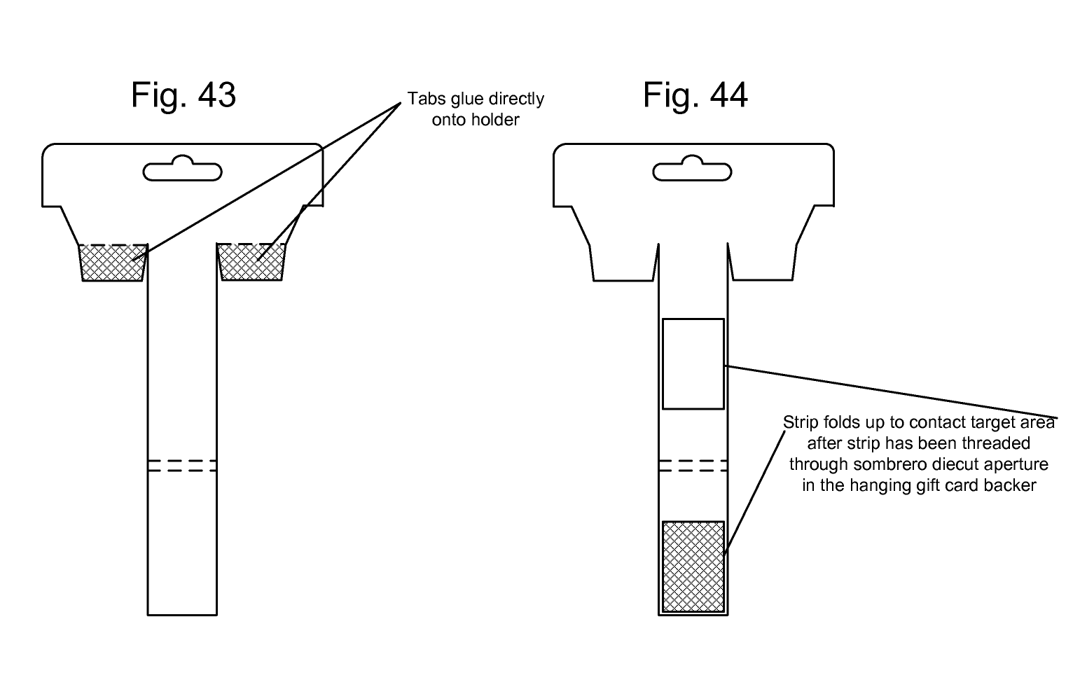

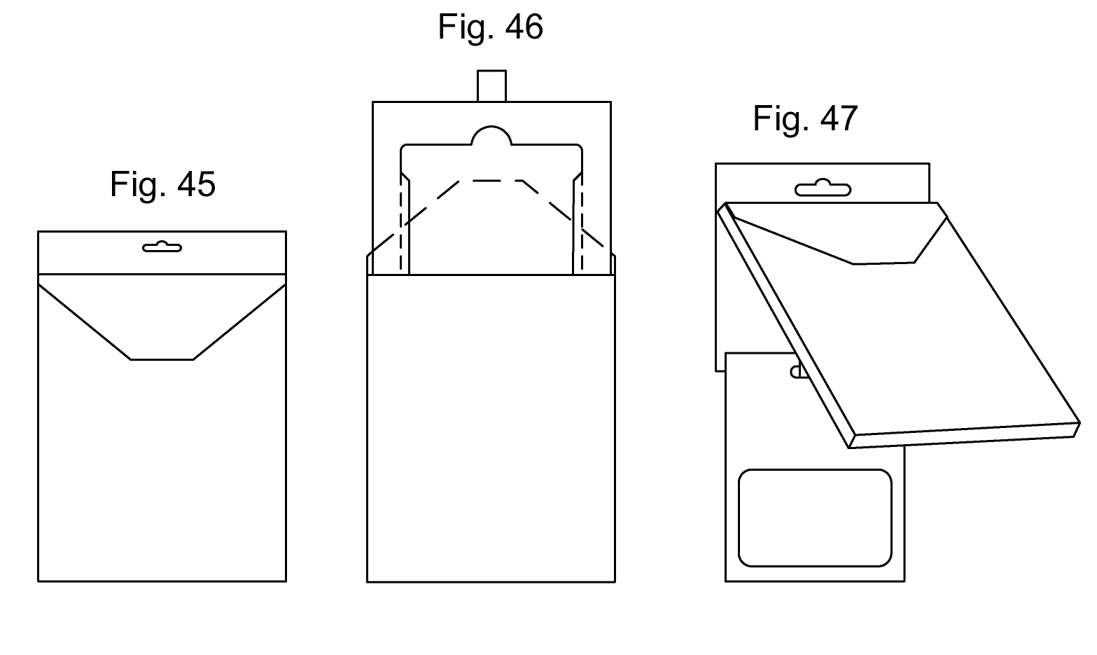

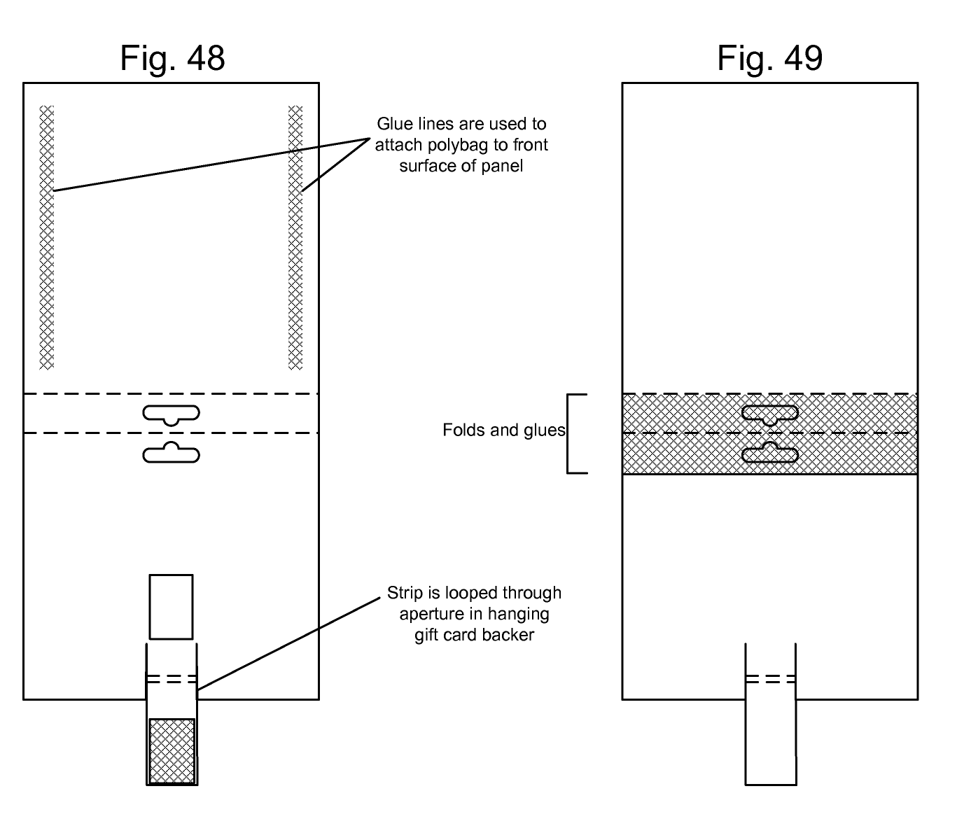

FIG. 19 is front view of an alternative embodiment of a gift card hanger system wherein the gift card holder 400 comprises three hingedly connected covers or panels: a left panel 405 that includes a slot or pocket 410 for retaining an inserted gift card 125 after removal of the gift card from a second backer panel 140, a center panel 415 that includes indicia 420 for prompting user indication of a gift giver, gift recipient and message, and a right panel 425 that also may bear indicia or decorations (not shown). One of the panels 405, 415 or 425 may include audio components (not shown) for providing sound upon opening the holder 400. As illustrated, a sliding switch arm 430 traverses from the center panel 415 to the left panel 405. The arm 430 is secured at its left end (as shown in FIG. 19) to the left panel 405 and at its right end to a switch mechanism housed internally within the center panel 415. When the left panel 405 is opened from a closed position overlying the center panel 415, the arm 430 is pulled by movement of the portion of the left panel 405 attached thereto away from the center panel 415 and a playback switch connected to the arm 430 is thereby activated by said arm movement.

Audio components of the illustrated gift card holder 400 are held within the interior of the center panel 415, which may comprise two panels of cardstock or similar material secured to one another substantially around the periphery of each. The audio components typically include a speaker for recording and playing back sound, a record button, control and storage circuitry including an integrated circuit and random access memory, a playback switch, and a power source such as one or more watch batteries. All or some of these audio components may be mounted upon a circuit board or similar structure. The circuit board is sized to fit within the interior of the center panel. An example of appropriate prior art circuitry of the type that may be adapted for use with this device includes a digital recording unit sold by Radio Shack, part no. 276-1323.

The holder 400 may include means for retaining the left and right panels 405 and 425 in a closed position. In the illustrated embodiment, cooperating hook and loop fastener elements, i.e. a portion of hook material and a separate portion of loop material, are placed, respectively, on the left and right panels 405 and 425 so that the align and come into contact with one another when the holder 400 is fully closed. As shown, one or the other of such elements is placed on the inside surface of the left cover as indicated by reference numeral 440, and the other of such elements is placed on the outside surface of the right panel 425 as indicated by reference numeral 445. To close the holder 400, the right panel 425 is folded leftward over the center panel 415, as shown in FIG. 20, and the left panel 405 is folded rightward over the outer surface of the right panel 425 so that the hook and loop elements 440 and 445 contact one another and form a temporary attachment to one another holding the gift card holder 400 in a secure, fully closed disposition. Further aspects of a three-panel holder 400 are disclosed in patent application Ser. No. 12/791,864, filed Jun. 1, 2010, and incorporated by reference herein.

Having thus described the invention, what is claimed as new and desired to be secured by Letters Patent is:

1. A transaction card hanger system comprising:
a transaction card assembly attached to a transaction card holder assembly by suspending the card assembly from the holder assembly by a looped tab secured at either end to the holder assembly.

2. The system of claim 1 wherein said transaction card assembly includes a panel bearing an attached transaction card.

3. The system of claim 1 wherein said transaction card holder assembly includes a panel bearing a transaction card holder.

4. A gift card holder system comprising:
gift card holder assembly including a first backer panel,
a detachable gift card holder attached to a face of said first backer panel,
an elongated tab extending from a lower portion of said first backer panel, said tab including a free end, and
a second backer panel including means for removably holding a gift card, said second backer panel including an aperture for accepting said free end therethrough, and
means for attaching said free end to said first backer panel.

5. The system of claim 4 wherein said holder comprises two hingedly connected panels and a means for holding a gift card.

6. The system of claim 4 wherein said holder comprises a container including a flap closure.

7. The system of claim 4 further comprising an aperture formed in an upper portion of said backer panel, said aperture sized to accept a display stand peg.

8. A transaction card hanger system comprising:
a transaction card holder assembly comprising a transaction card holder,
a tab extending from said transaction card holder assembly, said tab having a free end for passing through an aperture in a transaction card assembly, said transaction card assembly comprising a transaction card mounted upon a transaction card backer panel,
whereby said transaction card assembly may be suspended from said transaction card holder assembly by passing said free end through said aperture to attach to a surface of said transaction card holder assembly.
